(19) United States
(12) Patent Application Publication
(10) Pub. No.: US 2012/0053339 A1
(43) Pub. Date: Mar. 1, 2012

(54) Xanthan Gum with Fast Hydration and High Viscosity

(75) Inventors: Ross Clark, San Diego, CA (US); Harold Hayden, Borrego Springs, CA (US)

(73) Assignee: CP KELCO U.S., INC., Atlanta, GA (US)

(21) Appl. No.: 13/219,073

(22) Filed: Aug. 26, 2011

Related U.S. Application Data
(60) Provisional application No. 61/378,612, filed on Aug. 31, 2010.
(60) Provisional application No. 61/378,988, filed on Sep. 1, 2010.
(60) Provisional application No. 61/383,795, filed on Sep. 17, 2010.

(51) Int. Cl. C08B 37/00

(52) U.S. Cl. 536/114

(57) ABSTRACT

This disclosure provides for xanthan gum polymer, and methods of making thereof, having enhanced properties such as improved hydration tolerance, hydration rates, and/or viscosity properties, as compared to conventional xanthan gum, while maintaining beneficial xanthan gum properties such as enzyme stability and shear stability. The organism used in the fermentation to produce the disclosed xanthan gum typically is a strain of Xanthomonas campestris pathovar campestris. These and other aspects of the xanthan gum are described.

### CROSS REFERENCES TO RELATED APPLICATIONS

This patent application claims priority benefit of U.S. Provisional Application Nos. 61/378,612, filed Aug. 31, 2010; 61/378,988, filed Sep. 1, 2010; and 61/383,795, filed Sep. 17, 2010, each of which is incorporated herein by reference in their entireties.

### FIELD OF THE INVENTION

The invention relates to the field of microbial polymers. In particular, the invention relates to xanthan gum having improved properties such as enhanced hydration tolerance, faster hydration and higher viscosity.

### BACKGROUND OF THE INVENTION

Xanthan gum is a polyanionic polysaccharide used as a thickening, emulsifying and/or stabilizing agent in industrial (including construction, paints, paper, textiles, plant-protection, water-treatment and petroleum industries), food, cosmetic, agro-chemical and pharmaceutical formulations. Xanthan gum is produced commercially by aerobic fermentation of a bacterium Xanthomonas campestris.

Xanthan gum is generally supplied in a dry, powder form. Prior to use in a particular application, the xanthan gum is usually hydrated in an aqueous solution. In many cases, the solution used for hydration contains ions or other dissolved materials, which inhibit or even prevent full hydration of the xanthan gum. In those cases, the hydration medium has to be adjusted so as to contain lower levels of dissolved materials. When this adjustment is not possible, the effective use of xanthan gum might not be possible.

When hydrating xanthan gum in any medium, some time has to be allowed for the solvent to penetrate the dry powder, swell it and then allow it to diffuse into the hydration medium. This process takes time and requires mixing to continue until full hydration is obtained. If the mixing is stopped before the xanthan gum is fully hydrated a number of problems, including low viscosity result. A few techniques have been suggested to increase hydration including irradiating non-irradiated xanthan gum with ionizing radiation or providing a dry powder having a particle size of 60 to 250 microns with a mean diameter of 100-200 microns. However, the former results in an increase in product costs of the xanthan gum, and the latter fails to address the need for higher viscosity discussed below.

Since xanthan gum is often used as a thickener or suspending aid, many applications would benefit from having a xanthan gum that produces higher viscosity solutions either to provide more stability at the same use level or reduce the use level of xanthan gum and retain the same degree of stability. Thus, there have been many attempts to manufacture xanthan gum which when in solution exhibits a higher viscosity. One such method is heat treating (i.e. pasteurizing) the fermentation broth. This heat treatment leads to a conformational change which in turn results in a xanthan gum that produces solutions with a higher viscosity. However, this method can also result in impaired gum hydration due to the changes brought about by heating. Genetic manipulation of the xanthan organism such as over-expression of the gumB and gumC genes can result in higher viscosity solutions without pasteurization. However, genetically-modified products are not acceptable in many countries.

For the reasons discussed above, it would be advantageous to develop a powdered xanthan gum which when in solution can hydrate in a wide range of media, hydrate in a short period of time compared to conventional xanthan gum, and also provide a higher viscosity than traditional xanthan gum.

### SUMMARY OF THE INVENTION

The present invention provides a xanthan gum, and methods of making thereof, having more or more following properties in solution: (a) a Low Shear Rate Viscosity (LSRV) at 3 rpm of greater than about 1600 mPa·s (cP) when hydrated in standard tap water at a 0.25 weight percent (wt %) concentration of xanthan gum; (b) a Sea Water Viscosity (SWV) of greater than about 18 at 1 pound/barrel when hydrated in synthetic sea water; (c) a Hydration Rate of less than about 3 minutes in a 1 wt % NaCl solution at a 1 wt % concentration of xanthan gum; and (d) an ability to essentially fully hydrate in less than about 10 minutes in a 6 wt % NaCl solution at a 1 wt % concentration of xanthan gum.

In certain embodiments, the inventive xanthan gum exhibits properties comprising a Low Shear Rate Viscosity (LSRV) at 3 rpm of greater than about 1800 mPa·s (cP) when hydrated in standard tap water at a 0.25 weight percent (wt %) concentration of xanthan gum; a Low Shear Rate Viscosity (LSRV) at 3 rpm of greater than about 1750 mPa·s (cP) in a 0.01M NaCl solution at a 0.25 weight percent (wt %) concentration of xanthan gum; and/or a Low Shear Rate Viscosity (LSRV) at 3 rpm of greater than about 1700 mPa·s (cP) in a 0.1M NaCl solution at a 0.25 weight percent (wt %) concentration of xanthan gum.

In certain embodiments, the inventive xanthan gum exhibits properties comprising a Sea Water Viscosity (SWV) of greater than about 20 at 1 pound/barrel when hydrated in synthetic sea water. In certain embodiments, the inventive xanthan gum exhibits properties comprising a Hydration Rate of less than about 2 minutes in a 1 wt % NaCl solution at a 1 wt % concentration of xanthan gum, or less than about 4 minutes in a 3 wt % NaCl solution at a 1 wt % concentration of xanthan gum, or less than about 6 minutes in a 3 wt % citric acid solution at a 0.4 wt % concentration of xanthan gum. In certain embodiments, the inventive xanthan gum exhibits properties comprising an ability to essentially fully hydrate in less than about 8 minutes in a 6 wt % NaCl solution at a 1 wt % concentration of xanthan gum, or fully hydrate after about 1 hour of proper mixing at 1800 rpm under ambient conditions in a 10 wt % ammonium nitrate solution at a 0.2 wt % concentration of xanthan gum.

The inventive xanthan gum further exhibits properties comprising a viscosity, as measured using a Brookfield Model LV viscometer, No. 1 Spindle, at 3 rpm, after one hour of mixing at 1800 rpm under ambient conditions of greater than about 1900 mPa·s when hydrated in a 0.01M or 0.1 M NaCl solution at a 0.25 wt % concentration of xanthan gum; or greater than about 2100 mPa·s when hydrated in a 0.01 M or 0.1M NaCl solution at a 0.25 wt % concentration of xanthan gum.

The present invention further provides that the inventive xanthan gum is obtained from the fermentation of an Asian Xanthomonas campestris strain, i.e., Xanthomonas campestris pathover campestris, deposited with the American Type Culture Collection (ATCC) under the Accession No. PTA-11272. The present invention further provides that the inventive xanthan gum can be used as a thickener, viscosity modifier, emulsifier, or stabilizer in formulations for the drilling for or the assisted recovery of petroleum, for water treatment, for food, cosmetics, pharmaceutical or agrochemical formulations, for industrial or household cleaning, or for paper, construction, or textiles.

### BRIEF DESCRIPTION OF THE DRAWINGS

FIG. 1 illustrates Low Shear Rate Viscosity (LSRV) measurements for the inventive xanthan gum.

FIG. 2 illustrates Sea Water Viscosity (SWV) measurements for the inventive xanthan gum.

FIG. 3 illustrates a comparison of the hydration rates of the inventive xanthan gum and commercially available xanthan gums, in a 1 wt % NaCl solution at a 1 wt % concentration.

FIG. 4 illustrates a comparison of the hydration rates of the inventive xanthan gum and commercially available xanthan gums, in a 3 wt % NaCl solution at a 1 wt % concentration.

FIG. 5 illustrates a comparison of viscosities of the inventive xanthan gum and commercially available xanthan gums, in a 0.01M NaCl solution at a 0.25 wt % concentration, when measured using a Brookfield Model LV Viscometer, No. 1 spindle at 3 rpm.

FIG. 6 illustrates a comparison of viscosities of the inventive xanthan gum and commercially available xanthan gums, in a 0.1M NaCl solution at a 0.25 wt % concentration, when measured using a Brookfield Model LV Viscometer, No. 1 spindle at 3 rpm.

FIG. 7 illustrates equipment for determination of the hydration rate.

FIG. 8 illustrates placement of a stirrer in a sample cup in the equipment for determination of the hydration rate.

FIG. 9 illustrates an example of a torque curve generated in determining the hydration rate.

FIG. 10 illustrates a visual comparison of hydration of the inventive xanthan gum and commercially available xanthan gums in a difficult media (e.g., 6 wt % NaCl at a 1 wt % concentration).

### DETAILED DESCRIPTION OF THE INVENTION

Among other things, the present disclosure provides a xanthan gum polymer (“xanthan gum”) which exhibits unique characteristics when incorporated into various solutions. Xanthan gum is an extracellularly produced biogum made in aerobic fermentation by the bacteria Xanthomonas campestris. In one aspect, the organism used in the fermentation to produce the inventive xanthan gum is a strain of Xanthomonas campestris pathovar campestris. The fermentation requires a nitrogen source, a carbon source and other appropriate nutrients well known to those skilled in the art. During fermentation, the dissolved oxygen levels and temperature are maintained so as to provide the desired or optimal growth conditions for the bacteria.

The disclosure also provides for a xanthan gum which exhibits unique hydration and viscosity properties when in solution while maintaining typical xanthan gum properties with respect to, for example, enzyme stability and shear stability. The performance of xanthan gum in solutions may be measured by many different techniques under varying conditions of shear rates, polymer concentrations and hydration media. Regardless of the conditions, the inventive xanthan gum yields solutions which have viscosity values equal to and in most cases greater than previously known xanthan gums and has the ability to either hydrate faster or fully hydrate as compared to previously known xanthan gums. Thus, to quantify the performance of the inventive xanthan gum over the previously known xanthan gums various testing conditions are defined below and properties measured.

In one aspect, the xanthan gum when in solution exhibits properties comprising (i) a Low Shear Rate Viscosity (as defined below) at 3 rpm of greater than about 1600 mPa·s (cP) when hydrated in standard tap water (defined below) at a 0.25 weight percent (wt %) concentration of xanthan gum, (ii) a Sea Water Viscosity (as defined below) of greater than about 18 at 1 pound/barrel when hydrated in synthetic sea water, (iii) a Hydration Rate (as defined below) of less than about 3 minutes in a 1 wt % NaCl solution at a 1 wt % concentration of xanthan gum, and (iv) the ability to essentially fully hydrate in less than about 10 minutes in a 6 wt % NaCl solution at a 1 wt % concentration of xanthan gum.

In a further aspect, the xanthan gum provided herein when in solution exhibits any one or any combination of the following properties:
(i) a Low Shear Rate Viscosity (defined below) at 3 rpm of greater than about 1600 mPa·s (cP) when hydrated in standard tap water (defined below) at a 0.25 weight percent (wt %) concentration of xanthan gum;
(ii) a Sea Water Viscosity (as defined below) of greater than about 18 at 1 pound/barrel when hydrated in synthetic sea water;
(iii) a Hydration Rate (as defined below) of less than about 3 minutes in a 1 wt % NaCl solution at a 1 wt % concentration of xanthan gum;
(iv) the ability to essentially fully hydrate in less than about 10 minutes in a 6 wt % NaCl solution at a 1 wt % concentration of xanthan gum;
(v) the ability to obtain full hydration in about 1 hour of propeller mixing at 1800 rpm under ambient conditions in a 10 wt % ammonium nitrate solution at a 0.2 wt % concentration of xanthan gum;
(vi) a Low Shear Rate Viscosity (defined below) at 3 rpm of greater than about 1750 mPa·s (cP) in a 0.01 molar (M) NaCl solution at a 0.25 weight percent (wt %) concentration of xanthan gum;
(vii) a Low Shear Rate Viscosity (defined below) at 3 rpm of greater than about 1700 mPa·s (cP) in a 0.1 molar (M) NaCl solution at a 0.25 weight percent (wt %) concentration of xanthan gum; or
(viii) any combination thereof.
   In this aspect, the xanthan gum as provided in this disclosure when in solution exhibits any one or more than one of these properties, without limitation. Therefore, the inventive xanthan gum can exhibit any one, any two, any three, any four, any five, any six, or all of the listed properties.

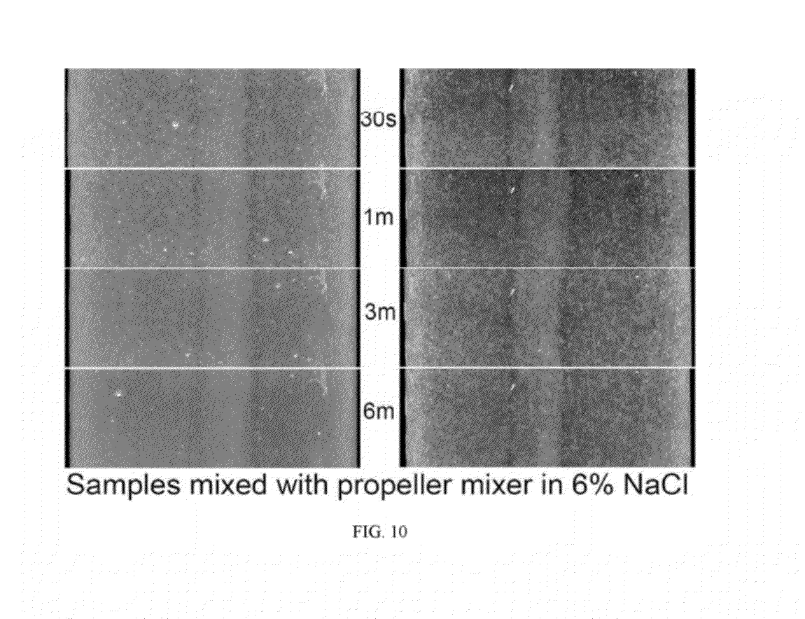

The terms “fully hydrate”, “essentially fully hydrate”, “full hydration”, “100% hydration”, and the like as used herein mean that the solution has a homogeneous appearance such that there is an absence of particles that are visible to the unaided human eye (as shown in FIG. 10) and the viscosity of the solution in the particular medium is not substantially changed from the viscosity obtained in standard tap water. The description “not substantially changed” is used herein to mean that the viscosity of the solution in the particular medium differs by less than about 25%, alternatively less than about 20%, alternatively less than about 15%, alternatively less than about 10%, alternatively less than about 7%, or alternatively less than about 5%, from the viscosity obtained in standard tap water. Standard tap water (STW) is prepared by dissolving 1.0 g of NaCl and 0.15 g CaCl₂2H₂O in 1 liter of deionized water.

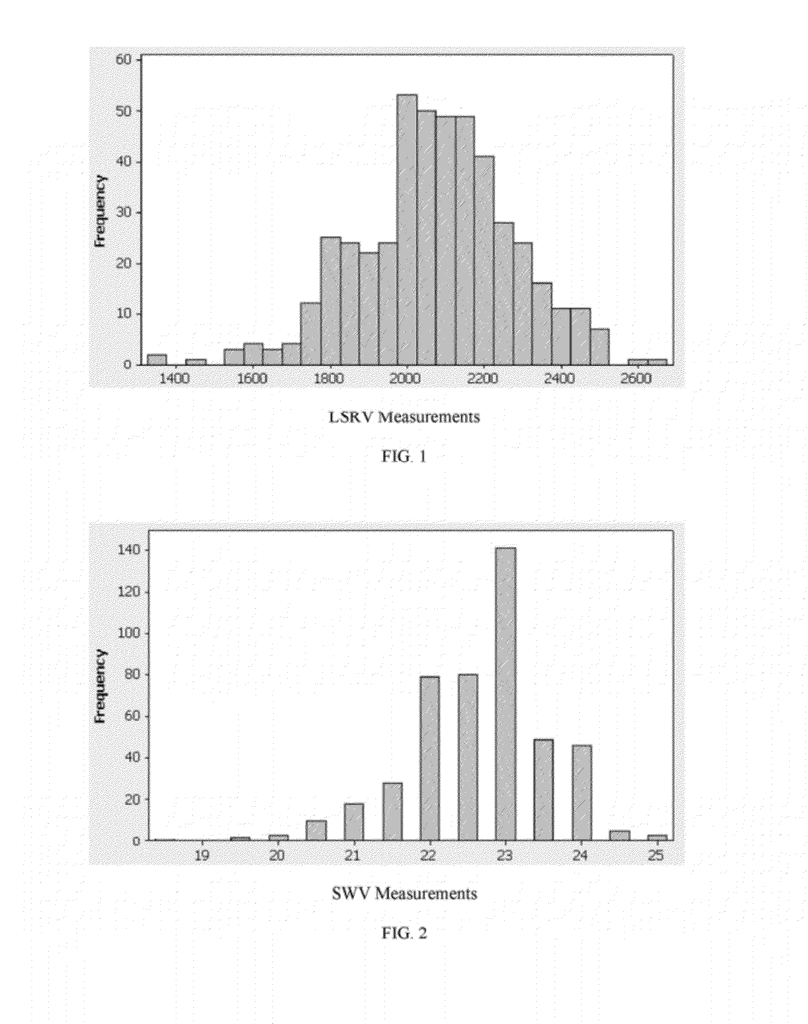

In another aspect, when the xanthan gum is hydrated in standard tap water to a 0.25 wt % concentration of xanthan gum, the resulting solution has a Low Shear Rate Viscosity at 3 rpm of greater than about 1800 mPa·s. In still another aspect, when hydrated in standard tap water to a 0.25 wt % concentration of xanthan gum, the solution has a Low Shear Rate Viscosity at 3 rpm of greater than about 2000 mPa·s. Representative data are provided in FIG. 1. As further illustrated in FIG. 1, when the xanthan gum provided according to this disclosure is hydrated in standard tap water to a 0.25 wt % concentration of xanthan gum, the solution can a Low Shear Rate Viscosity at 3 rpm of greater than about 1600 mPa·s, greater than about 1650 mPa·s, greater than about 1750 mPa·s, greater than about 1800 mPa·s, greater than about 1850 mPa·s, greater than about 1900 mPa·s, greater than about 1950 mPa·s, greater than about 2000 mPa·s, greater than about 2050 mPa·s, greater than about 2100 mPa·s, greater than about 2150 mPa·s, greater than about 2200 mPa·s, greater than about 2250 mPa·s, greater than about 2300 mPa·s, greater than about 2350 mPa·s, greater than about 2400 mPa·s, greater than about 2450 mPa·s, or greater than about 2500 mPa·s. Unless otherwise specified, under these conditions, when hydrated in standard tap water to a 0.25 wt % concentration of xanthan gum, the solution can have a Low Shear Rate Viscosity at 3 rpm of up to about 2700 mPa·s, up to about 2800 mPa·s, or up to about 2900 mPa·s.

In other aspects, the inventive xanthan gum exhibits properties of a Sea Water Viscosity of greater than about 20 at 1 pound/barrel and still further of a Sea Water Viscosity of greater than about 22 at 1 pound/barrel. Representative data are provided in FIG. 2. As further illustrated in FIG. 2, xanthan gum exhibits properties of a Sea Water Viscosity of greater than about 18.0 at 1 pound/barrel, greater than about 18.5 at 1 pound/barrel, greater than about 19.0 at 1 pound/barrel, greater than about 19.5 at 1 pound/barrel, greater than about 20.0 at 1 pound/barrel, greater than about 20.5 at 1 pound/barrel, greater than about 21.0 at 1 pound/barrel, greater than about 21.5 at 1 pound/barrel, greater than about 22.0 at 1 pound/barrel, greater than about 22.5 at 1 pound/barrel, greater than about 23.0 at 1 pound/barrel, greater than about 23.5 at 1 pound/barrel, or greater than about 24.0 at 1 pound/barrel. Unless otherwise specified, under these conditions, the xanthan gum exhibits properties of a Sea Water Viscosity of up to about 26.0 at 1 pound/barrel, up to about 27.0 at 1 pound/barrel, or up to about 28.0 at 1 pound/barrel.

In most applications, xanthan gum powder requires hydration before its use. In general terms, hydration can be considered a two step process. The first step that generally precedes the actual hydration step involves dispersing the xanthan gum in the desired medium so that individual particles are separated and not lumped together or aggregated. When xanthan gum particles stick and lump, hydration typically is much slower. Generally following this breakdown of aggregates, the second step occurs when these dispersed xanthan gum particles are actually hydrated in the medium, which means that the individual polymer molecules are released from the dry particle and are free to move in the medium. The industry terms of “dispersion” and “hydration” are used to describe these first and second steps, respectively.

Hydration itself has at least two aspects. One aspect of hydration concerns how rapidly the xanthan gum particles can swell and subsequently free the polymer chains, which has been defined herein as Hydration Rate. Quick and complete hydration can be important to many applications such as dry mixes. The second aspect of hydration concerns what type of medium will allow full hydration. Some hydration media are more difficult for the individual polymer molecules to be released from the dry particle and therefore, to fully hydrate in. For example, these more “difficult” media are usually high in salts, low in pH, and/or have high levels of dissolved non-ionic solids (such as sucrose or sugar alcohols) present. When the hydration medium is sufficiently difficult for the individual polymer molecules to hydrate in, then the gum particles are not able to swell and fully release the polymer. In such instances, excessive mixing, heat or a change in hydration medium may be required to use the polymer. In one aspect, one feature of the inventive xanthan gum is its ability to fully hydrate in these difficult media, including those that may be high in salts, low in pH, and/or have high levels of dissolved non-ionic solids, as compared to conventional xanthan gum. This aspect highlights a distinct disadvantage common in conventional xanthan gum, a disadvantage that the inventive xanthan gum overcomes. Since the types of media and the definition of “difficult” media are varied, one skilled in the art will appreciate that the inventive xanthan gum is being defined based on the properties that it exhibits is certain defined media.

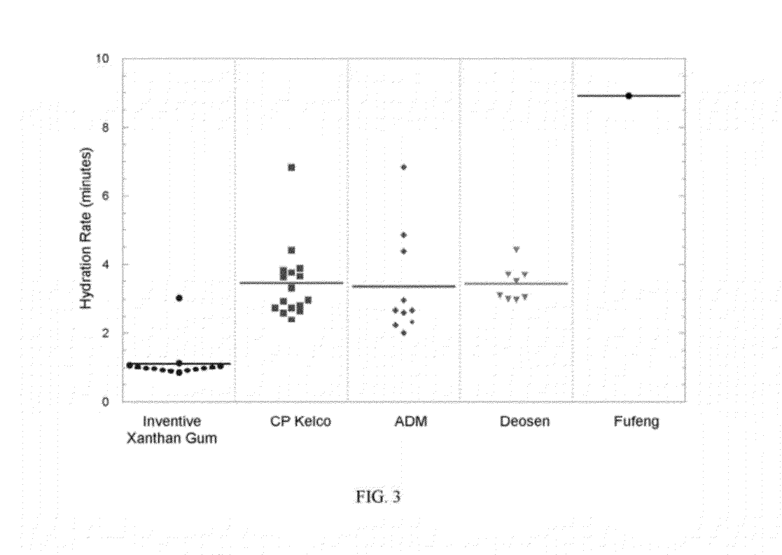

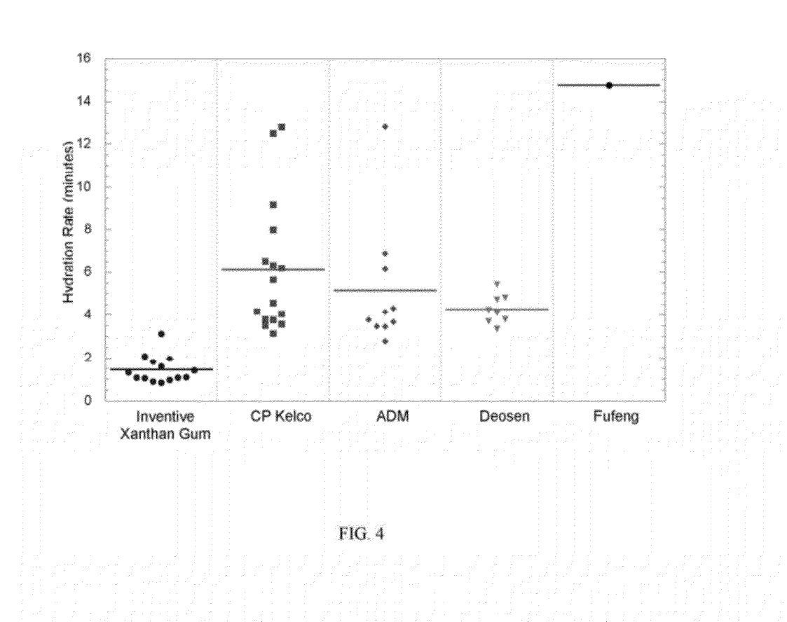

With respect to Hydration Rate, the inventive xanthan gum has solution properties, as follows. In one aspect, the xanthan gum has a Hydration Rate of less than about 3 minutes (as noted above), less than about 2.5 minutes, less than about 2 minutes, or less than about 1.5 minutes in a 1 wt % NaCl solution at a 1 wt % concentration of xanthan gum (FIG. 3). Even when the NaCl level of the solution is increased to 3 wt %, the xanthan gum at a 1 wt % concentration when in solution exhibits a Hydration Rate of less than about 4 minutes, less than about 3.5 minutes, less than about 3 minutes, less than about 2.5 minutes, or less than about 2 minutes (FIG. 4). In other media, such as a 3 wt % citric acid solution at a 0.4 wt % concentration of xanthan gum, the Hydration Rate is also relatively fast at less than about 6 minutes. For a solution of 40 wt % sucrose+4 wt % NaCl at a 0.35 wt % concentration of xanthan gum, the Hydration Rate is less than about 8 minutes.

In a further aspect, the inventive xanthan gum can be more tolerant of difficult hydration media. An example of this aspect is shown in FIG. 10 which provides visual evidence of the improved hydration in difficult media. In this case, 6 wt % NaCl was sufficient to inhibit the hydration of a conventional xanthan gum. Even after 6 minutes of mixing, visible amounts of unhydrated xanthan gum remain for the conventional xanthan gum (shown on the right side of FIG. 10). However, the inventive xanthan gum (shown on the left side of FIG. 10) fully hydrates in this medium. Thus, in one aspect, the inventive xanthan gum has the ability to essentially fully hydrate in less than about 10 minutes, less than about 9 minutes, less than about 8 minutes, less than about 7 minutes, or less than about 6 minutes in a 6 wt % NaCl solution at a 1 wt % concentration of xanthan gum. Thus, the inventive xanthan gum is fully hydrated as judged by visual appearance having an absence of visual particles (FIG. 10). Many xanthan gum systems require or benefit from having a xanthan gum with the ability to hydrate in difficult media. For example, food sauces or dressings have high levels of dissolved solids (sugar or corn syrup) along with high levels of salt and acid, and therefore generally constitute “difficult” media.

Further, the inventive xanthan gum is able to obtain full hydration in about 1 hour of propeller mixing at 1800 rpm under ambient conditions in a 10 wt % ammonium nitrate solution at a 0.2 wt % concentration of xanthan gum (3 rpm viscosity of 5000 mPa·s, Brookfield No. 1 spindle). Under these conditions, the inventive xanthan gum is able to obtain full hydration in about 0.7 hour, in about 0.8 hour, in about 0.9 hour, in about 1.0 hour, in about 1.1 hour, in about 1.2 hour, or in about 1.3 hour of propeller mixing at 1800 rpm under ambient conditions in a 10 wt % ammonium nitrate solution at a 0.2 wt % concentration of xanthan gum.

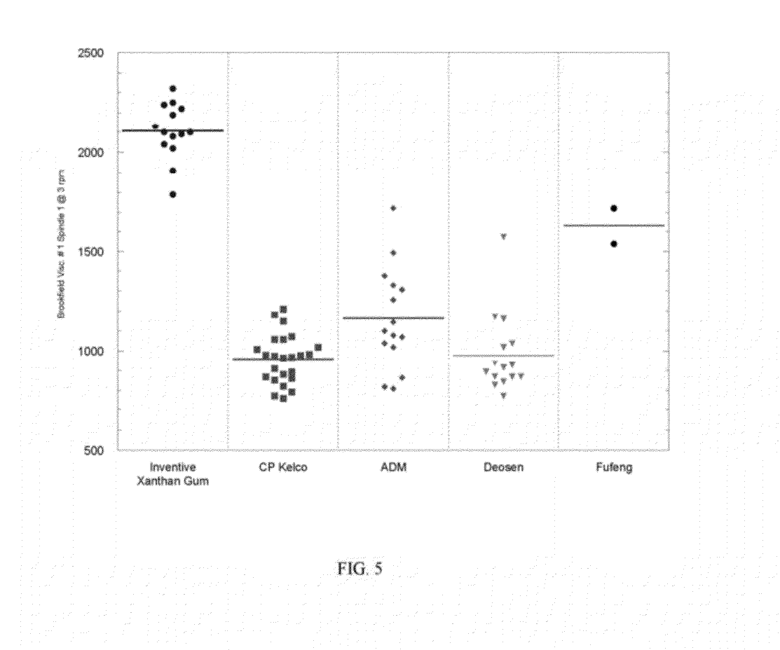

To demonstrate the superior thickening properties of the inventive xanthan gum, solution viscosities utilizing the inventive xanthan gum under varying salt concentrations were compared with conventional xanthan gum. As shown in FIG. 5, a comparison of the inventive xanthan gum with commercially available xanthan gums was demonstrated in which each xanthan gum was mixed in a 0.01 molar (M) NaCl solution at a 0.25 wt % concentration of xanthan gum for one hour at 1800 rpm under ambient conditions. The viscosities of the resulting solutions were measured using a Brookfield Model LV Viscometer, No. 1 spindle at 3 rpm. The inventive xanthan gum has a viscosity of greater than about 1750 mPa·s, greater than about 1800 mPa·s, greater than about 1850 mPa·s, greater than about 1900 mPa·s, greater than about 1950 mPa·s, greater than about 2000 mPa·s, greater than about 2050 mPa·s, or greater than about 2100 mPa·s. Unless otherwise specified, under these conditions, the inventive xanthan gum can have a viscosity of up to about 2400 mPa·s, up to about 2500 mPa·s, or up to about 2600 mPa·s. The comparative commercial xanthan gums exhibited significantly lower viscosities and may not have fully hydrated after one hour of mixing. Thus, these data demonstrate superior performance of the inventive xanthan gum over various commercially available xanthan gums in low salt environments.

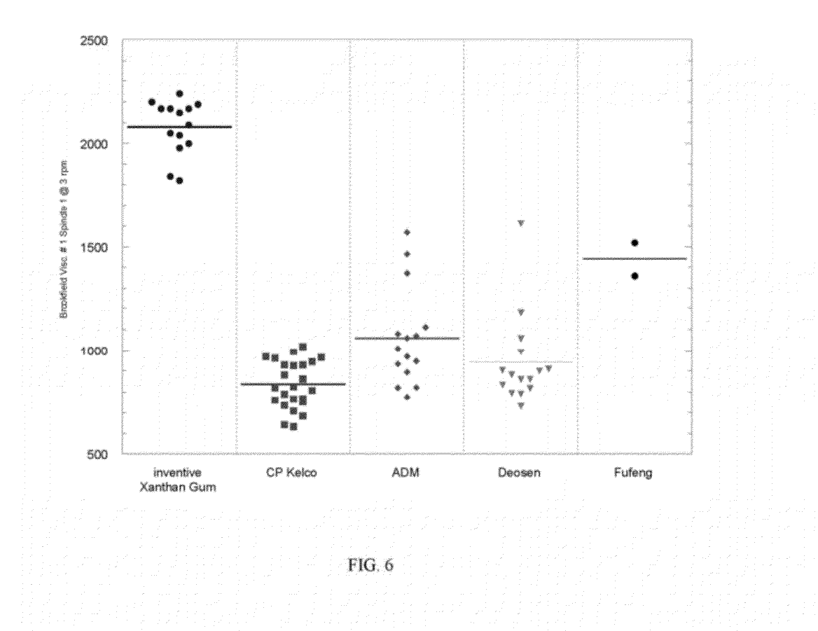

As shown in FIG. 6, a comparison of the inventive xanthan gum with commercially available xanthan gums was undertaken in which each xanthan gum was mixed in a 0.1M NaCl solution at a 0.25 wt % concentration of xanthan gum for one hour at 1800 rpm under ambient conditions. The viscosities of the resulting solutions were measured using a Brookfield Model LV Viscometer, No. 1 spindle at 3 rpm. In one aspect, the inventive xanthan gum has a viscosity of greater than about 1700 mPa·s, greater than about 1750 mPa·s, greater than about 1800 mPa·s, greater than about 1850 mPa·s, greater than about 1900 mPa·s, greater than about 1950 mPa·s, greater than about 2000 mPa·s, greater than about 2050 mPa·s, or greater than about 2100 mPa·s. Unless otherwise specified, under these conditions, the inventive xanthan gum can have a viscosity of up to about 2300 mPa·s, up to about 2400 mPa·s, up to about 2500 mPa·s, or up to about 2600 mPa·s. The comparative commercial xanthan gums exhibited significantly lower viscosities and may not have fully hydrated after one hour of mixing. Thus, the data demonstrated superior performance of the inventive xanthan gum over other commercially available xanthan gums in medium salt environments.

All of the above noted properties make it possible to incorporate the xanthan gum according to this disclosure as a thickener, viscosity modifier, emulsifier and/or stabilizer into formulations for paper, construction, textiles, food, cosmetics, agrochemical, pharmaceutical, industrial, household cleaning, drilling for and assisted recovery of petroleum, and water treatment. Xanthan gum is used as a component in a number of products to improve properties. The properties may include viscosity, suspension of particulates, mouth feel, bulk, water-binding, thickening, emulsion stabilizing, foam enhancing, and sheer-thinning. Food products using the inventive xanthan gum include, by way of example, salad dressings, syrups, juice drinks, and frozen desserts. Other products also include printing dyes, oil drilling fluids, ceramic glazes, and pharmaceutical compositions, cleaning liquids, paint and ink, wallpaper adhesives, pesticides, toothpastes, and enzyme and cell immobilizers. For pharmaceutical compositions, xanthan gum can be used as a carrier or as a controlled release matrix.

The xanthan gum is produced using conventional submerged Xanthomonas fermentation processes. In one aspect of the disclosure, Xanthomonas seed cultures may be produced in small scale using fermentation vessels from about 0.2 m³ to about 20 m³ over a period of about 20 to about 40 hours. The fermentations may be conducted under ambient conditions. Xanthomonas seed culture may be added to a full scale fermentation vessel of about 20 m³ to about 250 m³ along with a fermentation medium containing about 2.0 to about 6.0 wt % (preferably about 3.0 to about 4.0 wt %) carbon source in the form of corn starch, about 0.1 to about 0.5 wt % (preferably about 0.1 to about 0.3 wt %) nitrogen source in the form of soy protein, and about 0.005 to about 0.02 wt % (preferably 0.05 to about 0.015 wt %) calcium carbonate. Agitation and aeration may be provided during the fermentation to provide for oxygenation of the fermentation medium. The pH of the fermentation medium may be controlled in the range of about 6.0 to about 7.5 with the titrated addition of KOH or NaOH. After about 50 to about 100 hours, the fermentation is complete, resulting in a fermentation beer comprising an aqueous xanthan gum solution.

After fermentation is complete, the xanthan gum can be precipitated from the fermentation beer generally using an organic solvent that is miscible or at least somewhat miscible with water, for example, using an alcohol, a ketone or any other organic solvent that is miscible with water. The organic solvent conveniently may be used in any commercially available form, e.g., as an anhydrous solvent, as a mixture of alcohols or ketones (e.g., isomeric mixtures) or as a mixture of the organic solvent in water (e.g., azeotropic mixtures). In one aspect, the organic solvent can be an alcohol, such as methanol, ethanol, n-propanol, isopropanol (isopropyl alcohol), n-butanol, isobutanol, and the like, including any mixture or combination of alcohols. Further, the alcohol may be ethanol or isopropanol or a combination of ethanol or isopropanol. In still another aspect, to precipitate the xanthan gum, the organic solvent may be added to the fermentation beer in a volumetric ratio of at least about 0.5:1, that is, 0.5 volume of organic solvent for each volume of fermentation beer. In one aspect, the organic solvent may be added to the aqueous xanthan gum solution in a volumetric ratio of about 0.6:1 to about 3:1 of organic to beer. For example, ethanol may be added to the aqueous xanthan gum solution in a volumetric ratio of about 0.6:1 to about 3:1 of organic solvent to beer. In another aspect, the xanthan gum may be precipitated from the fermentation beer by adding ethanol in a volumetric ratio of about 1.25:1 to about 2.5:1 of ethanol to beer.

The xanthan gum precipitate may be separated or isolated using conventional techniques, e.g., by decantation. The isolated xanthan gum may be further treated as desired, for example, to remove excess solvent and/or improve the granularity of the xanthan gum product. In one aspect, the recovered xanthan gum may be pressed to remove excess alcohol and water and then dried. In a further aspect, the drying can be effected at a temperature of about 50° C. to about 90° C. until the residual moisture content is reduced to the desired level, for example, from about 5 to about 15 wt %. Moreover, if desired, the xanthan gum may be milled to an average particle size of about 50 to about 750 microns, for example.

It is considered to be within the ordinary skill of one in the art to subject the isolated xanthan gum product, as described herein, to any conventional post-fermentation/post-isolation treatment, as desired. However, the xanthan gum disclosed herein needs no post-fermentation or post-isolation treatment to obtain the desired properties as disclosed herein.

The test methods utilized herein to characterize the unique features of the xanthan gum according to this disclosure are as follows.

### Determination of Low Shear Rate Viscosity (“LSRV”) for Xanthan Gum.

LSRV for xanthan gum was determined using the following procedure. Xanthan gum (0.75 gm—weighed to the nearest 0.01 gm) was slowly added to 299 ml of standard tap water contained in a 400 ml tall form beaker while stirring at 800±20 rpm. Stirring was continued for approximately 4 hours. Just before removing the test solution from stirring (after 4 hours), the solution temperature was adjusted to 25±2° C. The test solution was removed from the stirrer and allowed to sit undisturbed at room temperature for 30±5 minutes (may be placed in a temperature-controlled water bath). After the solution sat for 30 minutes, the temperature was measured by inserting a thermometer into the solution between the center and the side of the beaker. For accuracy, the solution was not disturbed prior to measuring the viscosity. The viscosity at 25±2° C. was measured using a Brookfield Model LV Viscometer, No. 1 spindle at 3 rpm. The viscosity in millipascal second (“mPa·s”) or centipoises (“cP”) was recorded after allowing the spindle to rotate for 3 minutes.

### Determination of Seawater Viscosity for Xanthan Gum.

Sea water solution was prepared according to ASTM D1141-52 by dissolving 41.95 g of sea salt, from Lake Products Co., Inc., Maryland Heights, Mo. in 1 liter deionized water. A 300 ml portion of sea water solution was transferred to a mixing cup that was attached to a Hamilton-Beach 936-2 mixer (Hamilton-Beach Div., Washington, D.C.). The mixer speed control was set to low and a single fluted disk was attached to the mixing shaft. At the low speed setting, the mixer shaft rotated at approximately 4,000-6,000 rpm. A 0.86 g portion of xanthan gum was slowly added over 15-30 seconds to the mixing cup and allowed to mix for 5 minutes. The mixer speed control was set to high (11,000±1,000 rpm) and the test solution was allowed to mix for approximately 5 minutes. The mixture was allowed to mix for a total of 45 minutes, starting from time of xanthan gum addition. At the end of the 45 minutes mixing time, 2-3 drops of BARA-DEFOAM® defoaming agent (NL Baroid/NL Industries, Inc., Houston, Tex.) was added and stirring was continued for an additional 30 seconds. The mixing cup was removed from the mixer and immersed in chilled water to lower the fluid's temperature to 25° C.±0.5° C. In order to insure a homogeneous solution, the solution was re-mixed after cooling for 5 seconds at 11,000±1,000 rpm. The solution was transferred from the mixing cup to 400 ml Pyrex beaker and Fann viscosity (Fann Viscometer, Model 35A) was measured. This was accomplished by mixing at 3 rpm. The reading was allowed to stabilize and then the shear stress value was read from dial and recorded as the Sea Water Viscosity value at 3 rpm.

### Determination of Hydration Rate for Xanthan Gum.

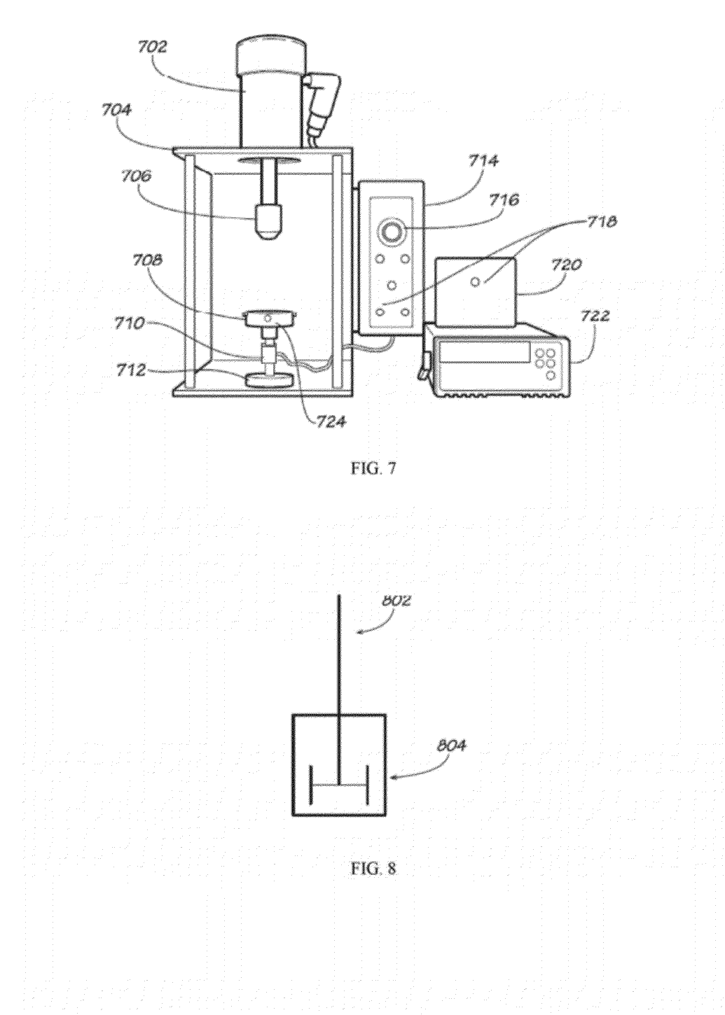

A Hydration Rate tester was developed to measure the Hydration Rate of xanthan gum in an aqueous solution. Hydration Rate is defined as the amount of time for the sample to reach 90% of maximum torque. While this does not directly measure full hydration, the 90% point is a useful metric for sample comparison. The 100% point obtained is more variable since the approach to the final value is gradual and is affected by even small amounts of random error in the measurement. The instrument as shown in FIG. 7 utilized a variable speed motor to stir the solvent in a beaker that was mounted to a torque sensing load cell. The xanthan gum was added to the solvent while mixing at a constant speed to begin the test. As solution viscosity built due to the hydration of the xanthan gum, the torque (twisting force) on the beaker increased. The torque values were continuously monitored by a computer which normalized, printed and plotted the data in terms of percent torque versus time. While torque was not a direct measure of the viscosity of the sample, torque provided a valuable measure of the viscosity development over time.

Equipment for determination of Hydration Rate is shown in FIG. 7 and FIG. 8:

1. Test Frame (704)—the body of the instrument securing the variable speed motor (702), SCR controller (714) and torque load cell (710). The torque load cell mounting plate (712) was designed to be quickly removable and self aligning. The controller (714) has a speed control knob (716) and on/off power switch (718).
2. Torque Load Cell (710) and Signal Conditioner (720)—the torque sensing load cell (710) measured very small forces. The signal conditioner (720) electronically sensed the changes in torque on the load cell (710) and electronically sent this information to the digital multi-voltmeter (722). The signal conditioner (720) has an on/off power switch (718).
3. Motor (702)—a DC variable speed motor (702) and appropriate chuck (706) were used for this tester. The speed range was approximately 0-1200 rpm with a high degree of stability (±5 rpm).
4. Multimeter (722)—digitized the voltage readings from the signal conditioner (720) and sent the information to the computer. Readings were taken at 5 per second to 5 significant digits.
5. H-Bar Stirrer (802)—the H-bar stirrer (802) as shown in FIG. 8 has the following dimensions: overall length 8 in., length to cross member 7 in., 1.5 in.×1.5 in. in “H” (0.25 in. stainless dowel used). The H-bar stirrer (802) was specifically designed to mix the solution while maintaining a vortex within the solution, at a 2-4 mm clearance from the bottom.
6. Sample cup (804)—a 250 ml stainless steel Griffin beaker (804) was used to hold the solvent. The sample cup (804) is held by a sample cup holder (708), and secured by sample cup positioning screws (724).
7. Tachometer—a digital photo tachometer was used to accurately adjust stirrer (802) speed.

Hydration Rate Procedure: The test used 80 mesh particle size xanthan gum, which was dispersed in polyethylene glycol (PEG) at a weight ratio of 3:1 and hand mixed at room temperature (23±2° C.). Samples to be tested were mixed with the dispersant immediately before the test was started. The solute was varied as noted in the examples and figures below. Standard tap water (STW), one of the solutes, was prepared by dissolving 1.0 g of NaCl and 0.15 g CaCl₂.2H₂O in 1 liter of deionized water. A volume of 130 ml was used. Xanthan gum was tested at the 1 wt % level, unless noted otherwise. Stirrer speed was 600 rpm. The sample was added over a 4-5 second period of time in a very controlled and constant fashion. For consistency and accuracy, the sample must not be added too fast or slow or in an uneven manner.

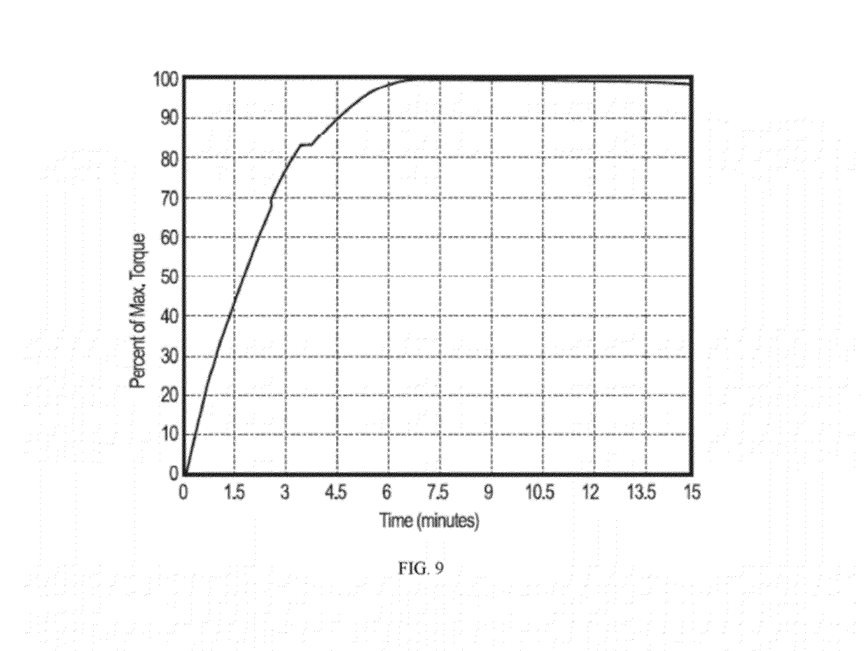

The data were scaled from 0 to 100% of the maximum torque that occurred during the test. The time to reach 90% of maximum torque was taken as the Hydration Rate. This value was found to be stable and repeatable. The time to reach 100% was not used because the final approach to 100% torque was gradual and subjected to extraneous factors such as electrical noise and or vibration. An example of a torque curve generated in this manner is provided in FIG. 9.

### EXAMPLES

In the following examples, the organism used in the fermentations was an Asian strain of Xanthomonas campestris pathovar campestris, which was deposited with the American Type Culture Collection (ATCC, Patent Depository, 1081 University Boulevard, Manassas, Va. 20110-2209, United States of America) on Aug. 31, 2010 under the Accession No. PTA-11272.

The fermentations were conducted under ambient conditions. Xanthomonas seed culture was added to a fermentation vessel along with a fermentation medium containing 3.8 wt % carbon source (corn starch) and 0.25 wt % nitrogen source (soy protein) and 0.01 wt % CaCO₃. Agitation and aeration were provided at conventional rates during the fermentation to provide for adequate oxygenation of the fermentation medium. The pH of the fermentation medium was controlled during fermentation in the range of about 6.0 to 7.5 with addition of KOH. After about 60 hours, the fermentation was complete and the xanthan gum was precipitated from the fermentation beer by adding 1.5 volumes of ethanol to the fermentation beer. The recovered xanthan gum was pressed to remove excess alcohol and water and then dried at a temperature of 70° C. until the residual moisture content was 10 wt %. Finally, the xanthan gum was milled to an average particle size of 80 microns.

In each of the examples as shown in FIGS. 1-6 and 10 and Tables 1-4, the inventive xanthan gum was compared to commercially available 80 mesh xanthan gums available from CP Kelco U.S., Inc. under the trade name KELTROL® and KELZAN®, Archer Daniels Midland Company under the trade name OPTIZXAN® and NOVAXAN®, Shandong Deosen Corporation Ltd. under the trade name ZIBOXAN®, Fufeng Group Ltd. xanthan gum and Cargill, Incorporated under the trade name VERSAGUM®.

TABLE 1
Hydration of 0.4% xanthan gum in 3% citric acid (1 hour mixing)

| | | | 3 rpm viscosity |
|---|---|---|---|
| | Hydration Rate | Hydration | (mPa · s), Brookfield |
| Product | (minutes) | extent (%) | No. 1 spindle |
| Inventive xanthan gum | 5.2 minutes | 100 | 11,100 |
| CP Kelco | 32 minutes | 61 | 5,000 |
| ADM | 28 minutes | 81 | 6,080 |

TABLE 2
Hydration of 0.2% xanthan gum in 10% ammonium nitrate (1 hour mixing)

| | | 3 rpm viscosity |
|---|---|---|
| | | (mPa · s), Brookfield |
| Product | Hydration extent (%) | No. 1 spindle |
| Inventive xanthan gum | 100 | 5000 |
| KELZAN: | 61 | 1040 |
| ADM | 78 | 2480 |

TABLE 3
Viscosity (60 rpm, Brookfield No. 1 spindle, mPa · s)
of 0.4% xanthan gum at 23° C.

| | Initial, 1 hr | | | |
|---|---|---|---|---|
| 4% citric acid | mix | 1 week | 2 weeks | 3 weeks |
| Inventive xanthan gum | 423 | 405 | 400 | 365 |
| Kelzan ASX-T | 327 | 341 | 357 | 357 |
| ADM | 380 | 351 | 337 | 305 |
| 2% sulfamic acid | Initial | 1 week | 2 weeks | 3 weeks |
| Inventive xanthan gum | 404 | 337 | 310 | 305 |
| Kelzan ASX-T | 258 | 295 | 299 | 308 |
| ADM | 310 | 246 | 231 | 230 |

TABLE 4
Viscosity (60 rpm, Brookfield No. 1 spindle, mPa · s)
of 0.4% xanthan gum held at 50° C.

| | Initial, 1 hr | | | |
|---|---|---|---|---|
| | mix | 1 week | 2 weeks | 3 weeks |
| 4% citric acid | | | | |
| Inventive xanthan gum | 423 | 310 | 315 | 326 |
| Kelzan ASX-T | 327 | 308 | 320 | 320 |
| ADM | 380 | 215 | 212 | 201 |
| 2% sulfamic acid | | | | |
| Inventive xanthan gum | 404 | 270 | 202 | 92 |
| Kelzan ASX-T | 258 | 241 | 181 | 85 |
| ADM | 310 | 145 | 98 | 52 |

In another example, FIG. 10 shows how the inventive xanthan gum (photos on the left side) compared to standard xanthan gum from CP Kelco (right side) in a 6 wt % NaCl solution at a 1 wt % concentration of xanthan gum. At a series of elapsed times (30 s, 1 m, 3 m and 6 m) the solution being mixed was photographed. The sides of the photo are the beaker and the shape in the middle is the stirrer shaft. Each photo shows both bubbles (sharp round light areas) and unhydrated xanthan gum (light grey masses). As the xanthan gum hydrated, the unhydrated xanthan gum became progressively less visible until such time as it became not visible. The inventive xanthan gum was not visible after 6 minutes. The standard xanthan gum was showing many more unhydrated areas, which did not disappear with mixing. Among other things, the photos of FIG. 10 illustrate how visual methods can be used to distinguish gum hydration.

Unless indicated otherwise, when a range of any type is disclosed or claimed, it is intended that the recited range is inclusive of the upper and lower limits of the range. Therefore, the terms “between” or “in a range” and similar terms are intended to mean from the lower limit of the range to the upper limit of the range, inclusive. Moreover, and unless indicated otherwise, when a range of any type is disclosed or claimed, for example a range of concentrations, viscosities or temperatures and the like, it is intended to disclose or claim individually each possible number that such a range could reasonably encompass, including any sub-ranges encompassed therein. For example, when describing a viscosity of between about 2400 mPa·s and about 2600 mPa·s, it is intended that each possible number that such a range could reasonably encompass is included in this disclosure, usually to values within the range with one significant digit more than is present in the end points of a range. In this example, by disclosing a viscosity from about 2400 mPa·s to about 2600 mPa·s, such disclosure is intended to be equivalent to disclosing a viscosity of about 2400 mPa·s, about 2410 mPa·s, about 2420 mPa·s, about 2430 mPa·s, about 2440 mPa·s, about 2450 mPa·s, about 2460 mPa·s, about 2470 mPa·s, about 2480 mPa·s, about 2490 mPa·s, about 2500 mPa·s, about 2510 mPa·s, about 2520 mPa·s, about 2530 mPa·s, about 2540 mPa·s, about 2550 mPa·s, about 2560 mPa·s, about 2570 mPa·s, about 2580 mPa·s, about 2590 mPa·s, or about 2600 mPa·s, including any ranges, subranges, or any combinations of ranges or subranges between these recited numbers, inclusive. Accordingly, Applicants reserve the right to proviso out or exclude any individual members of any such group, including any sub-ranges or combinations of sub-ranges within the group, if for any reason Applicants choose to claim less than the full measure of the disclosure, for example, to account for a reference that Applicants are unaware of at the time of the filing of the application.

In any application before the United States Patent and Trademark Office, the Abstract of this application is provided for the purpose of satisfying the requirements of 37 C.F.R. §1.72 and the purpose stated in 37 C.F.R. §1.72(b) “to enable the United States Patent and Trademark Office and the public generally to determine quickly from a cursory inspection the nature and gist of the technical disclosure.” Therefore, the Abstract of this application is not intended to be used to construe the scope of the claims or to limit the scope of the subject matter that is disclosed herein. Moreover, any headings that may be employed herein are also not intended to be used to construe the scope of the claims or to limit the scope of the subject matter that is disclosed herein. Any use of the past tense to describe an example otherwise indicated as constructive or prophetic is not intended to reflect that the constructive or prophetic example has actually been carried out.

What is claimed is:

1. A xanthan gum having the following properties in solution:
a. a Low Shear Rate Viscosity at 3 rpm of greater than about 1600 mPa·s when hydrated in standard tap water at a 0.25 weight percent (wt %) concentration of xanthan gum,
b. a Sea Water Viscosity of greater than about 18 at 1 pound/barrel when hydrated in synthetic sea water,
c. a Hydration Rate of less than about 3 minutes in a 1 wt % NaCl solution at a 1 wt % concentration of xanthan gum, and
d. an ability to essentially fully hydrate in less than about 10 minutes in a 6 wt % NaCl solution at a 1 wt % concentration of xanthan gum.

2. The xanthan gum of claim 1 further exhibiting properties comprising a Low Shear Rate Viscosity at 3 rpm of greater than about 1800 mPa·s when hydrated in standard tap water to a 0.25 wt % concentration of xanthan gum.

3. The xanthan gum of claim 1 further exhibiting properties comprising a Sea Water Viscosity of greater than about 20 at 1 pound/barrel.

4. The xanthan gum of claim 1 further exhibiting properties comprising a Hydration Rate of less than about 2 minutes in a 1 wt % NaCl solution at a 1 wt % concentration of xanthan gum.

5. The xanthan gum of claim 1 further exhibiting properties comprising a Hydration Rate of less than about 4 minutes in a 3 wt % NaCl solution at a 1 wt % concentration of xanthan gum.

6. The xanthan gum of claim 1 further exhibiting properties comprising a Hydration Rate of less than about 6 minutes in a 3 wt % citric acid solution at a 0.4 wt % concentration of xanthan gum.

7. The xanthan gum of claim 1 further exhibiting properties comprising the ability to essentially fully hydrate in less than about 8 minutes in a 6 wt % NaCl solution at a 1 wt % concentration of xanthan gum.

8. The xanthan gum of claim 1 further exhibiting properties comprising full hydration after about 1 hour of propeller mixing at 1800 rpm under ambient conditions in a 10 wt % ammonium nitrate solution at a 0.2 wt % concentration of xanthan gum.

9. The xanthan gum of claim 1 further exhibiting properties comprising a viscosity, as measured using a Brookfield Model LV viscometer, No. 1 Spindle, at 3 rpm, after one hour of mixing at 1800 rpm under ambient conditions of greater than about 1900 mPa·s when hydrated in a 0.01M NaCl solution at a 0.25 wt % concentration of xanthan gum.

10. The xanthan gum of claim 1 further exhibiting properties comprising a viscosity, as measured using a Brookfield Model LV viscometer, No. 1 Spindle, at 3 rpm, after one hour of mixing at 1800 rpm under ambient conditions of greater than about 2100 mPa·s when hydrated in a 0.01M NaCl solution at a 0.25 wt % concentration of xanthan gum.

11. The xanthan gum of claim 1 further exhibiting properties comprising a viscosity, as measured using a Brookfield Model LV viscometer, No. 1 Spindle, at 3 rpm, after one hour of mixing at 1800 rpm under ambient conditions of greater than about 1900 mPa·s when hydrated in a 0.1M NaCl solution at a 0.25 wt % concentration of xanthan gum.

12. The xanthan gum of claim 1 further exhibiting properties comprising a viscosity, as measured using a Brookfield Model LV viscometer, No. 1 Spindle, at 3 rpm, after one hour of mixing at 1800 rpm under ambient conditions of greater than about 2100 mPa·s when hydrated in a 0.1M NaCl solution at a 0.25 wt % concentration of xanthan gum.

13. The xanthan gum of claim 1 being used as a thickener, viscosity modifier, emulsifier, or stabilizer in formulations for the drilling for or the assisted recovery of petroleum, for water treatment, for food, cosmetics, pharmaceutical or agrochemical formulations, for industrial or household cleaning, or for paper, construction or textiles.

14. The xanthan gum of claim 1, wherein the xanthan gum is obtained from the fermentation of Xanthomonas campestris.

15. The xanthan gum of claim 14, wherein the Xanthomonas campestris is a strain having an ATCC Accession No. PTA-11272.

16. The xanthan gum of claim 1, wherein the xanthan gum is obtained from the fermentation of Xanthomonas campestris pathovar campestris.

17. The xanthan gum of claim 1, wherein the xanthan gum is in a dehydrated state.

18. A xanthan gum having the following properties in solution:
a. a Low Shear Rate Viscosity at 3 rpm of greater than about 1600 mPa·s (cP) when hydrated in standard tap water at a 0.25 weight percent (wt %) concentration of xanthan gum;
b. a Sea Water Viscosity of greater than about 18 at 1 pound/barrel when hydrated in synthetic sea water;
c. a hydration rate of less than about 3 minutes in a 1 wt % NaCl solution at a 1 wt % concentration of xanthan gum;
d. an ability to essentially fully hydrate in less than about 10 minutes in a 6 wt % NaCl solution at a 1 wt % concentration of xanthan gum;
e. an ability to obtain full hydration in about 1 hour of propeller mixing at 1800 rpm under ambient conditions in a 10 wt % ammonium nitrate solution at a 0.2 wt % concentration of xanthan gum;
f. a Low Shear Rate Viscosity at 3 rpm of greater than about 1750 mPa·s (cP) in a 0.01 molar (M) NaCl solution at a 0.25 weight percent (wt %) concentration of xanthan gum;
g. a Low Shear Rate Viscosity at 3 rpm of greater than about 1700 mPa·s (cP) in a 0.1 molar (M) NaCl solution at a 0.25 weight percent (wt %) concentration of xanthan gum; or
h. any combination thereof.

19. The xanthan gum of claim 18, wherein the xanthan gum is obtained from the fermentation of Xanthomonas campestris pathovar campestris.

20. The xanthan gum of claim 19, wherein the Xanthomonas campestris is a strain having an ATCC Accession No. PTA-11272.
